(19) United States
(12) Patent Application Publication
(10) Pub. No.: US 2026/0222798 A1
(43) Pub. Date: Jul. 30, 2026

(54) DEVICE AND METHOD FOR PERFORMING ONLINE TRAINING OF TRANSCEIVER MODEL IN WIRELESS COMMUNICATION SYSTEM

(71) Applicant: LG ELECTRONICS INC., Seoul (KR)

(72) Inventors: Kyungho LEE, Seoul (KR); Bonghoe KIM, Seoul (KR); Sangrim LEE, Seoul (KR); Yeongjun KIM, Seoul (KR)

(73) Assignee: LG ELECTRONICS INC., Seoul (KR)

(21) Appl. No.: 19/147,666

(22) PCT Filed: Jan. 13, 2023
(86) PCT No.: PCT/KR2023/000658

§ 371 Date: Jul. 11, 2025

(51) Int. Cl. H04W 8/24; G06N 3/0985

(52) U.S. Cl. CPC H04W 8/24; G06N 3/0985

(57) ABSTRACT

The objective of the present disclosure is to perform online training of a receiver model in a wireless communication system. An operating method of a user equipment (UE) may comprise the steps of: transmitting capability information to a base station; receiving configuration information related to signals from the base station; receiving the signals on the basis of the configuration information; determining at least one parameter for a reception operation by performing meta learning on the basis of meta correlation information, which is determined using the signals and represents the contribution of task model parameters of a plurality of tasks to a target task; and transmitting feedback information to the base station.

### CROSS-REFERENCE TO RELATED APPLICATION(S)

This application is the National Stage filing under 35 U.S.C. 371 of International Application No. PCT/KR2023/000658, filed on Jan. 13, 2023, contents of which are all incorporated by reference herein in its entirety.

### TECHNICAL FIELD

The following description relates to a wireless communication system, and more particularly, to an apparatus and method for performing online learning for a transceiver model in a wireless communication system.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure may provide an apparatus and method for effectively performing online learning for transceiver models in a wireless communication system.

The present disclosure may provide a device and method for performing meta-learning of a transceiver model in a wireless communication system.

The present disclosure may provide a device and method for applying the concept of quasi co-location (QCL) to meta-learning of a transceiver model in a wireless communication system.

The present disclosure may provide a device and method for performing meta-learning based on meta-correlation for a transceiver model in a wireless communication system.

The present disclosure may provide a device and method for determining meta model parameters based on meta-correlation in a wireless communication system.

The present disclosure may provide a device and method for determining meta-correlation information based on contributions of a plurality of tasks in a wireless communication system.

The present disclosure may provide a device and method for sharing capability information for meta-learning based on meta-correlation of a transceiver model in a wireless communication system.

The present disclosure may provide a device and method for providing configuration information for meta-learning based on meta-correlation of a transceiver model in a wireless communication system.

The present disclosure may provide a device and method for sharing information related to results of meta-learning based on meta-correlation of a transceiver model in a wireless communication system.

The present disclosure may provide a device and method for reporting meta-correlation information based on contributions of a plurality of tasks in a wireless communication system.

The technical objectives of the present disclosure are not limited to the aforementioned aspects, and other technical objectives not explicitly mentioned may be recognized by those skilled in the relevant art from the embodiments of the present disclosure described below.

According to an embodiment of the present disclosure, a method for operating a user equipment (UE) in a wireless communication system, the method may include: transmitting, to a base station, capability information; receiving, from the base station, configuration information related to signals; receiving the signals based on the configuration information; determining at least one parameter for a reception operation by performing meta-learning based on meta-correlation information that represents contributions of task model parameters of a plurality of tasks to a target task, the meta-correlation information being determined using the signals; and transmitting, to the base station, feedback information.

According to an embodiment of the present disclosure, a method for operating a base station in a wireless communication system, the method may include: receiving, from a user equipment (UE), capability information; transmitting, to the UE, configuration information related to signals; transmitting the signals based on the configuration information; receiving, from the UE, feedback information, wherein the feedback information is related to at least one parameter for a reception operation determined by performing meta-learning based on meta-correlation information that represents contributions of task model parameters of a plurality of tasks to a target task, the meta-correlation information being determined using the signals.

According to an embodiment of the present disclosure, a user equipment (UE) in a wireless communication system, the UE may include: a transceiver; and a processor connected to the transceiver, wherein the processor is configured to perform operations may include: transmitting, to a base station, capability information; receiving, from the base station, configuration information related to signals; receiving the signals based on the configuration information; determining at least one parameter for a reception operation by performing meta-learning based on meta-correlation information that represents contributions of task model parameters of a plurality of tasks to a target task, the meta-correlation information being determined using the signals; and transmitting, to the base station, feedback information.

According to an embodiment of the present disclosure, a base station in a wireless communication system, the base station may include: a transceiver; and a processor connected to the transceiver, wherein the processor is configured to perform operations may include: transmitting, to the UE, configuration information related to signals; transmitting the signals based on the configuration information; receiving, from the UE, feedback information, wherein the feedback information is related to at least one parameter for a reception operation determined by performing meta-learning based on meta-correlation information that represents contributions of task model parameters of a plurality of tasks to a target task, the meta-correlation information being determined using the signals.

According to an embodiment of the present disclosure, a communication device may include: at least one processor; a processor connected to the transceiver, at least one computer memory connected to the at least one processor and storing instructions that, based on being executed by the at least one processor, cause the device to perform operations, wherein the operations may include: transmitting, to a base station, capability information; receiving, from the base station, configuration information related to signals; receiving the signals based on the configuration information; determining at least one parameter for a reception operation by performing meta-learning based on meta-correlation information that represents contributions of task model parameters of a plurality of tasks to a target task, the meta-correlation information being determined using the signals; and transmitting, to the base station, feedback information.

According to an embodiment of the present disclosure, a non-transitory computer-readable medium storing at least one instruction, comprising the at least one instruction being executable by a processor, wherein the at least one instruction is configured to perform operations may include: transmitting, to a base station, capability information; receiving, from the base station, configuration information related to signals; receiving the signals based on the configuration information; determining at least one parameter for a reception operation by performing meta-learning based on meta-correlation information that represents contributions of task model parameters of a plurality of tasks to a target task, the meta-correlation information being determined using the signals; and transmitting, to the base station, feedback information.

The above-described aspects of the present disclosure are merely some of the preferred embodiments of the present disclosure, and various embodiments reflecting the technical features of the present disclosure may be derived and understood by those of ordinary skill in the art based on the following detailed description of the disclosure.

As is apparent from the above description, the embodiments of the present disclosure have the following effects.

According to the present disclosure, online learning of a transceiver model, particularly meta-learning, may be performed effectively.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 shows an example of a communication system applicable to the present disclosure.

FIG. 2 shows an example of a wireless device applicable to the present disclosure.

FIG. 3 shows another example of a wireless device applicable to the present disclosure.

FIG. 4 shows an example of a hand-held device applicable to the present disclosure.

FIG. 5 shows an example of a car or an autonomous driving car applicable to the present

### DISCLOSURE

FIG. 6 shows an example of artificial intelligence (AI) device applicable to the present disclosure.

FIG. 7 shows a method of processing a transmitted signal applicable to the present disclosure.

FIG. 8 shows an example of a communication structure providable in a 6th generation (6G) system applicable to the present disclosure.

FIG. 9 shows an electromagnetic spectrum applicable to the present disclosure.

FIG. 10 shows a THz communication method applicable to the present disclosure.

FIG. 11 shows a perceptron architecture in an artificial neural network applicable to the present disclosure.

FIG. 12 shows an artificial neural network architecture applicable to the present disclosure.

FIG. 13 shows a deep neural network applicable to the present disclosure.

FIG. 14 shows a convolutional neural network applicable to the present disclosure.

FIG. 15 shows a filter operation of a convolutional neural network applicable to the present disclosure.

FIG. 16 shows a neural network architecture with a recurrent loop applicable to the present disclosure.

FIG. 17 shows an operational structure of a recurrent neural network applicable to the present disclosure.

FIG. 18 shows a concept of meta-learning applicable to the present disclosure.

FIGS. 19a and 19b show examples of data sets for meta-learning applicable to the present disclosure.

FIG. 20 shows functional structures of devices that support meta-learning according to an embodiment of the present disclosure.

FIG. 21 shows a procedure for determining parameters related to a transmitter according to an embodiment of the present disclosure.

FIG. 22 shows a procedure for determining parameters related to a receiver according to an embodiment of the present disclosure.

FIG. 23 shows a procedure for determining meta-model parameters according to an embodiment of the present disclosure.

FIG. 24 shows an example procedure for providing capability information for meta-learning based on meta-correlation for a receiver, according to an embodiment of the present disclosure.

FIG. 25 shows an example procedure for configuring information for meta-learning according to an embodiment of the present disclosure.

FIG. 26 shows an example procedure for performing meta-learning and tasks according to an embodiment of the present disclosure.

FIG. 27 shows an example procedure for performing online meta-learning according to an embodiment of the present disclosure.

FIG. 28 shows an example procedure for reporting meta-correlation information according to an embodiment of the present disclosure.

FIG. 29 shows an example use-case in which tasks are performed by employing meta-correlation according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. In this case, the term “BS” may be replaced with a fixed station, a Node B, an eNB (eNode B), a gNB (gNode B), an ng-eNB, an advanced base station (ABS), an access point, etc.

In addition, in the embodiments of the present disclosure, the term terminal may be replaced with a user equipment (UE), a mobile station (MS), a subscriber station (SS), a mobile subscriber station (MSS), a mobile terminal, an advanced mobile station (AMS), etc.

In addition, a transmitter is a fixed and/or mobile node that provides a data service or a call service and a receiver is a fixed and/or mobile node that receives a data service or a call service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology after TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.XXX.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

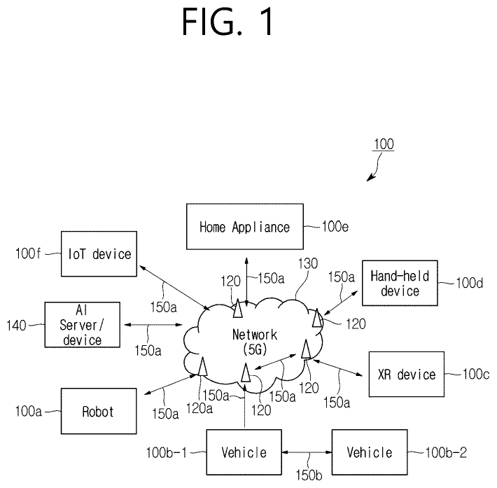

FIG. 1 shows an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

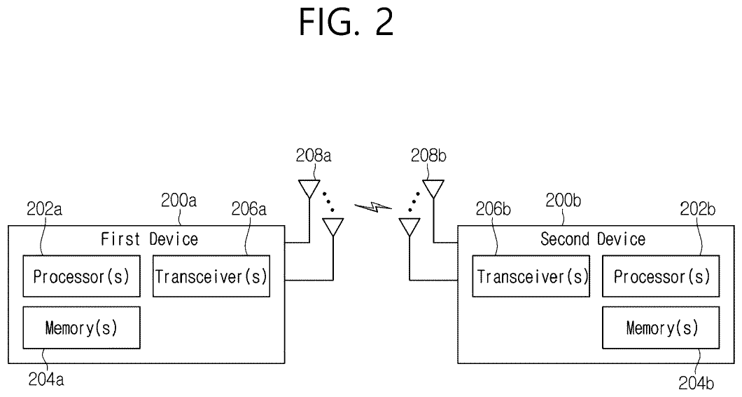

FIG. 2 shows an example of a wireless device applicable to the present disclosure.

Referring to FIG. 2, a first wireless device 200a and a second wireless device 200b may transmit and receive radio signals through various radio access technologies (e.g., LTE or NR). Here, (the first wireless device 200a, the second wireless device 200b) may correspond to (the wireless device 100x, the base station 120) and/or (the wireless device 100x, the wireless device 100x) of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, or One or more microprocessors microcomputers. processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

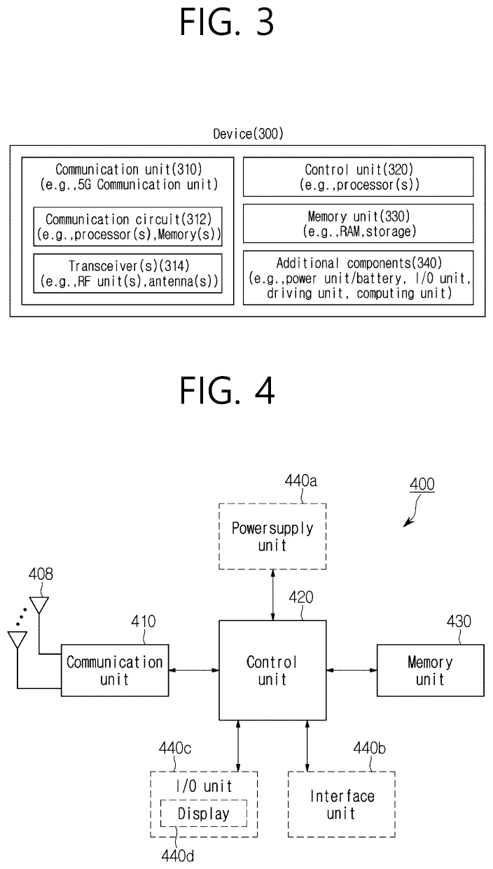

FIG. 3 shows another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device a based on program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

FIG. 4 shows an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

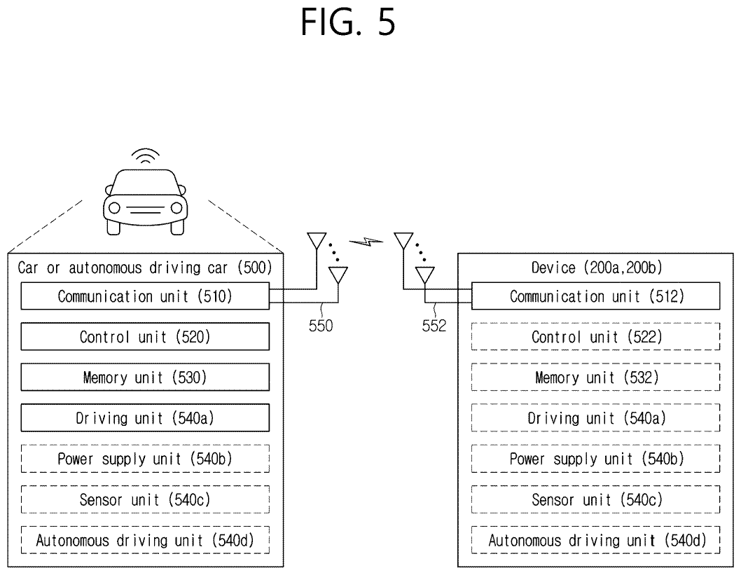

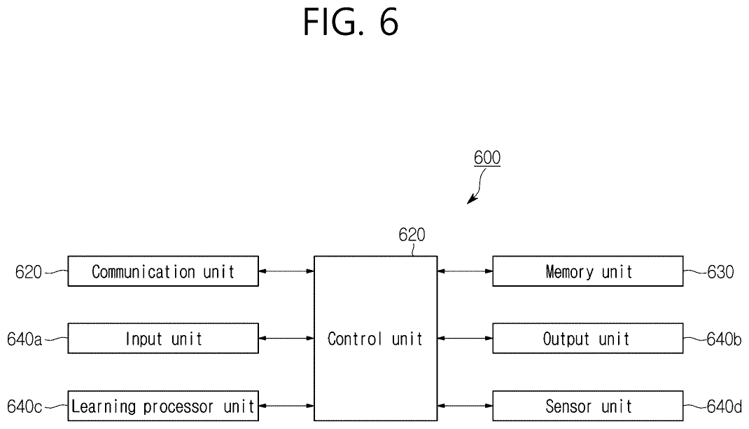

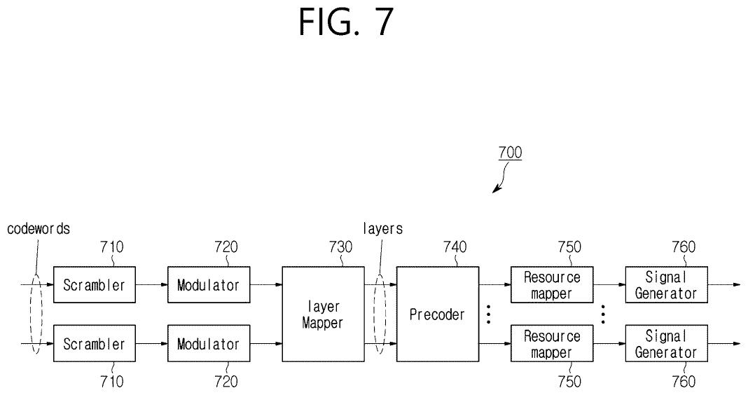

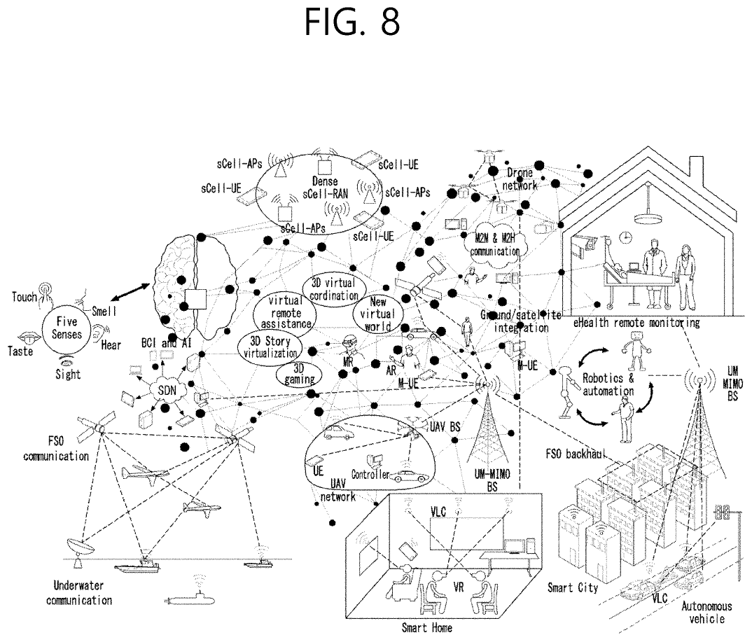

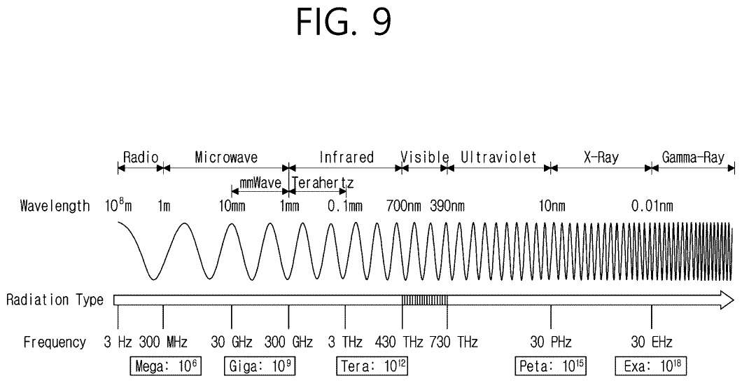

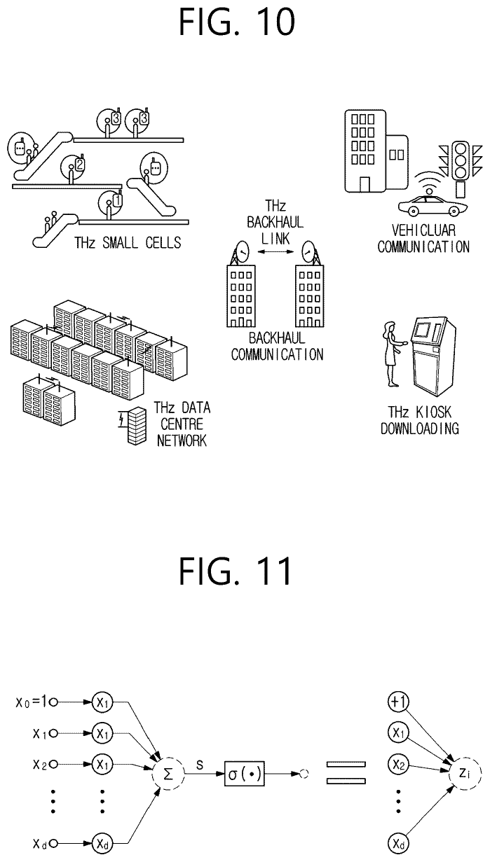

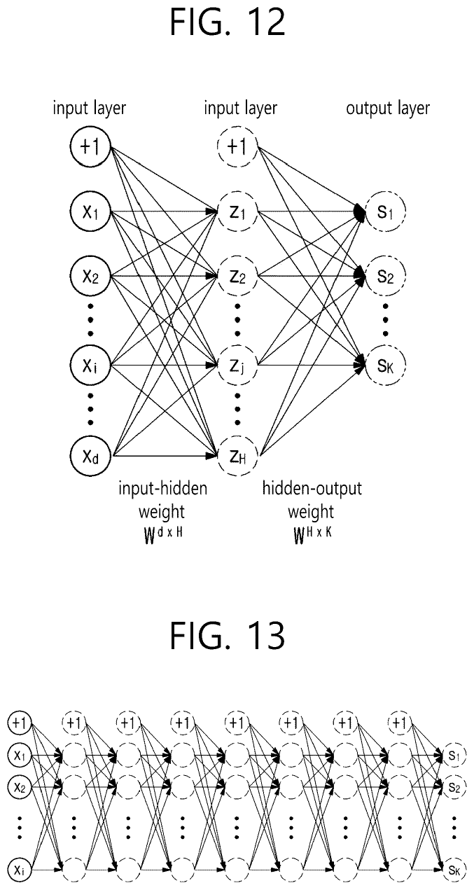

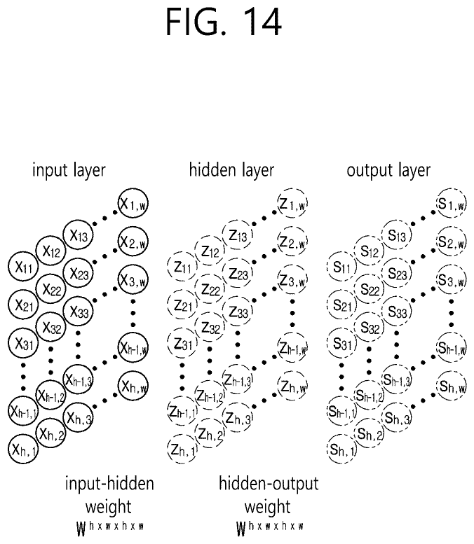

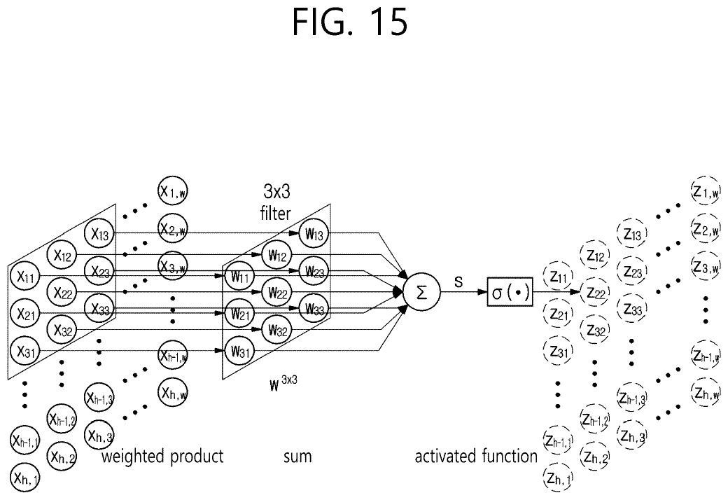

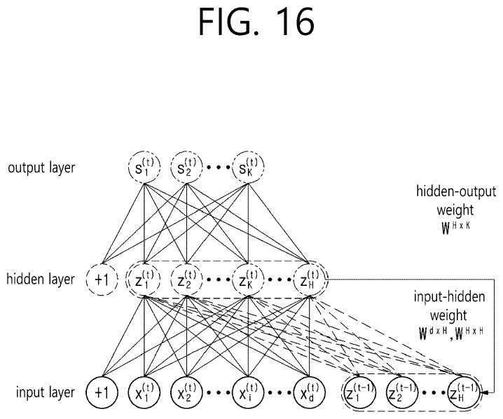

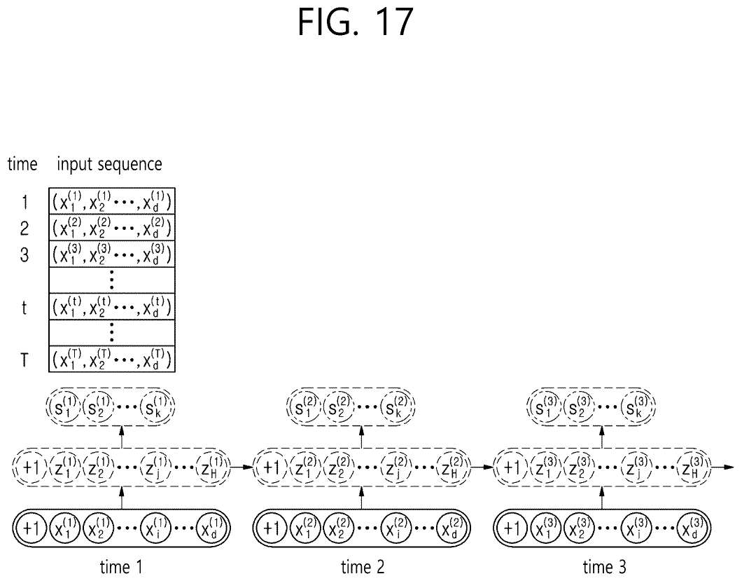

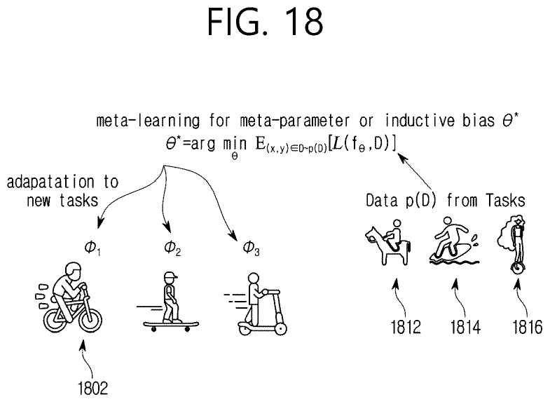

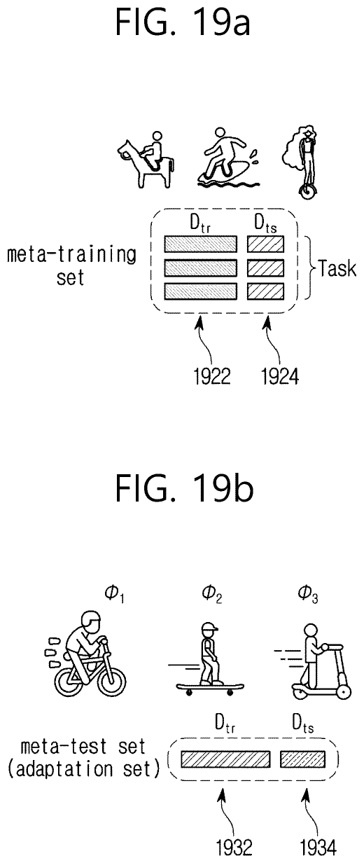

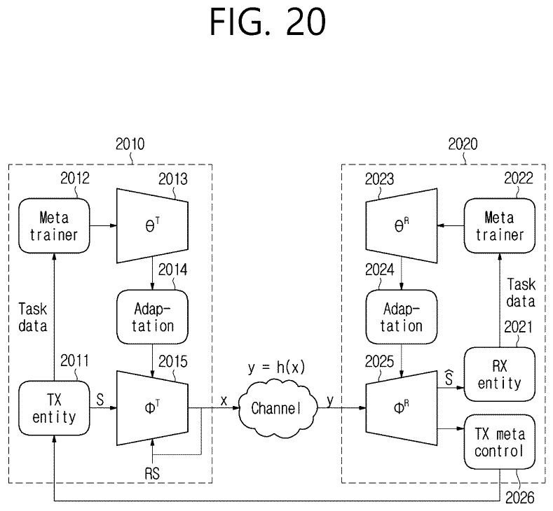

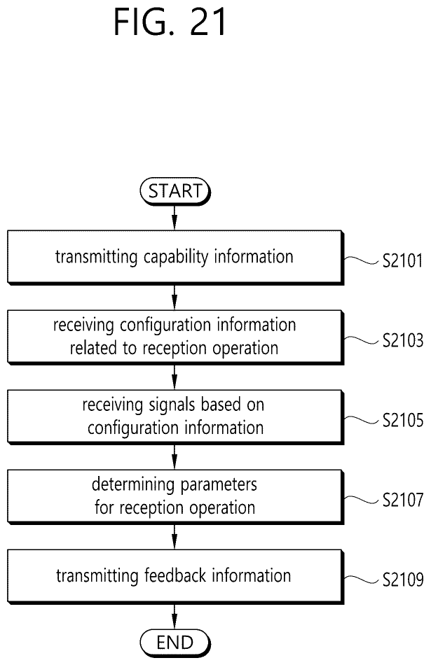

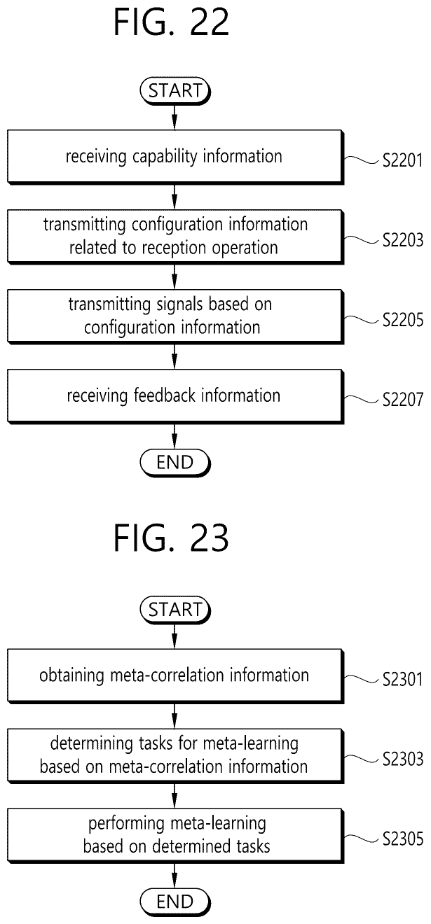

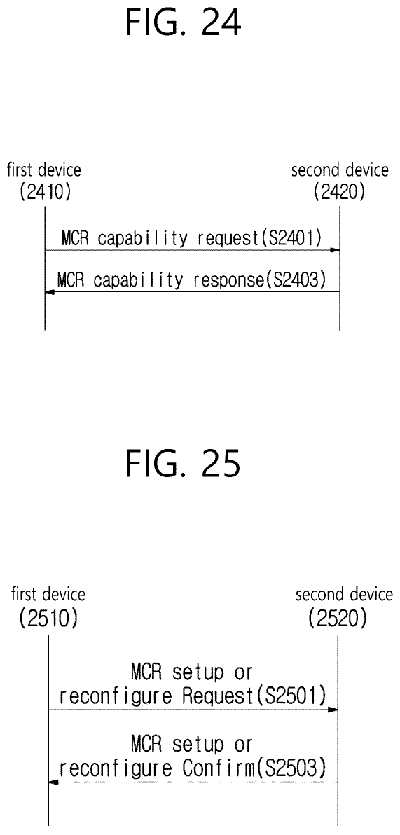

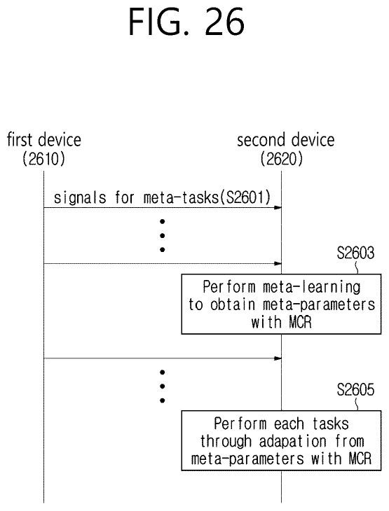

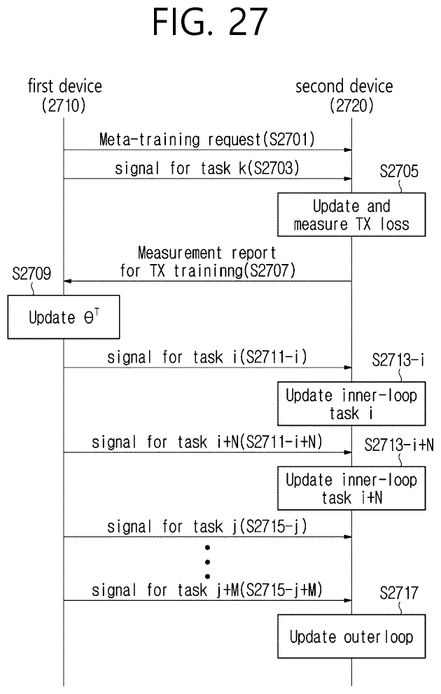

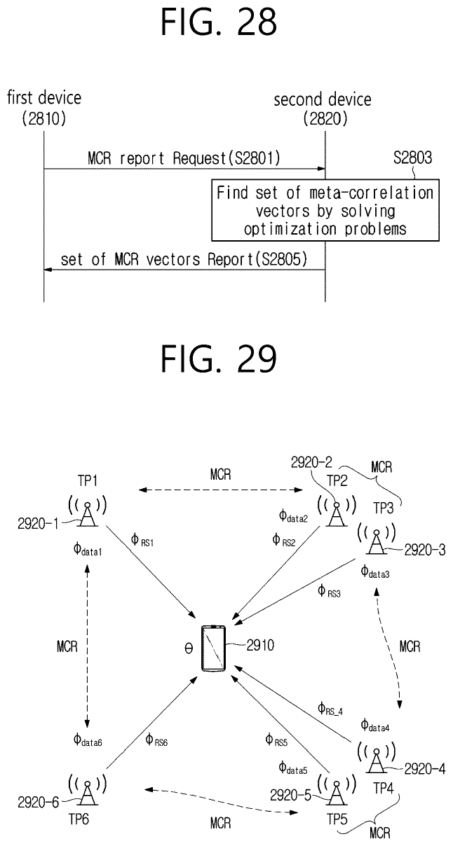

FIG. 5 shows an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

FIG. 6 shows an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 6, the AI device 600 may include a communication unit (transceiver) 610, a control unit (controller) 620, a memory unit (memory) 630, an input/output unit 640 a/640 b, a leaning processor unit (learning processor) 640c and a sensor unit 640d. The blocks 610 to 630/640a to 640d may correspond to the blocks 310 to 330/340 of FIG. 3, respectively.

The communication unit 610 may transmit and receive wired/wireless signals (e.g., sensor information, user input, learning models, control signals, etc.) to and from external devices such as another AI device (e.g., FIG. 1, 100x, 120 or 140) or the AI server (FIG. 1, 140) using wired/wireless communication technology. To this end, the communication unit 610 may transmit information in the memory unit 630 to an external device or transfer a signal received from the external device to the memory unit 630.

The control unit 620 may determine at least one executable operation of the AI device 600 based on information determined or generated using a data analysis algorithm or a machine learning algorithm. In addition, the control unit 620 may control the components of the AI device 600 to perform the determined operation. For example, the control unit 620 may request, search for, receive or utilize the data of the learning processor unit 640c or the memory unit 630, and control the components of the AI device 600 to perform predicted operation or operation, which is determined to be desirable, of at least one executable operation. In addition, the control unit 620 may collect history information including operation of the AI device 600 or user's feedback on the operation and store the history information in the memory unit 630 or the learning processor unit 640c or transmit the history information to the AI server (FIG. 1, 140). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensing unit 640. In addition, the memory unit 630 may store control information and/or software code necessary to operate/execute the control unit 620.

The input unit 640a may acquire various types of data from the outside of the AI device 600. For example, the input unit 640a may acquire learning data for model learning, input data, to which the learning model will be applied, etc. The input unit 640a may include a camera, a microphone and/or a user input unit. The output unit 640b may generate video, audio or tactile output. The output unit 640b may include a display, a speaker and/or a haptic module. The sensing unit 640 may obtain at least one of internal information of the AI device 600, the surrounding environment information of the AI device 600 and user information using various sensors. The sensing unit 640 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 640c may train a model composed of an artificial neural network using training data. The learning processor unit 640c may perform AI processing along with the learning processor unit of the AI server (FIG. 1, 140). The learning processor unit 640c may process information received from an external device through the communication unit 610 and/or information stored in the memory unit 630. In addition, the output value of the learning processor unit 640c may be transmitted to the external device through the communication unit 610 and/or stored in the memory unit 630.

FIG. 7 shows a method of processing a transmitted signal applicable to the present disclosure. For example, the transmitted signal may be processed by a signal processing circuit. At this time, a signal processing circuit 700 may include a scrambler 710, a modulator 720, a layer mapper 730, a precoder 740, a resource mapper 750, and a signal generator 760. At this time, for example, the operation/function of FIG. 7 may be performed by the processors 202a and 202b and/or the transceiver 206a and 206b of FIG. 2. In addition, for example, the hardware element of FIG. 7 may be implemented in the processors 202a and 202b of FIG. 2 and/or the transceivers 206a and 206b of FIG. 2. For example, blocks 710 to 760 may be implemented in the processors 202a and 202b of FIG. 2. In addition, blocks 710 to 750 may be implemented in the processors 202a and 202b of FIG. 2 and a block 760 may be implemented in the transceivers 206a and 206b of FIG. 2, without being limited to the above-described embodiments.

A codeword may be converted into a radio signal through the signal processing circuit 700 of FIG. 7. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH). Specifically, the codeword may be converted into a bit sequence scrambled by the scrambler 710. The scramble sequence used for scramble is generated based in an initial value and the initial value may include ID information of a wireless device, etc. The scrambled bit sequence may be modulated into a modulated symbol sequence by the modulator 720. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 730. Modulation symbols of each transport layer may be mapped to corresponding antenna port(s) by the precoder 740 (precoding). The output z of the precoder 740 may be obtained by multiplying the output y of the layer mapper 730 by an N*M precoding matrix W. Here, N may be the number of antenna ports and M may be the number of transport layers. Here, the precoder 740 may perform precoding after transform precoding (e.g., discrete Fourier transform (DFT)) for complex modulation symbols. In addition, the precoder 740 may perform precoding without performing transform precoding.

The resource mapper 750 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 760 may generate a radio signal from the mapped modulation symbols, and the generated radio signal may be transmitted to another device through each antenna. To this end, the signal generator 760 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 710 to 760 of FIG. 7. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |
| Mobility support | Up to 1000 | km/hr |

| | |
|---|---|
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

FIG. 10 shows an example of a communication structure providable in a 6G system applicable to the present disclosure.

Referring to FIG. 10, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

### Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel measurement and channel tracking and may be used for power allocation, interference cancellation, etc. in the physical layer of DL. In addition, machine learning may be used for antenna selection, power control, symbol detection, etc. in the MIMO system.

However, application of a deep neutral network (DNN) for transmission in the physical layer may have the following problems.

Deep learning-based AI algorithms require a lot of training data in order to optimize training parameters. However, due to limitations in acquiring data in a specific channel environment as training data, a lot of training data is used offline. Static training for training data in a specific channel environment may cause a contradiction between the diversity and dynamic characteristics of a radio channel.

In addition, currently, deep learning mainly targets real signals. However, the signals of the physical layer of wireless communication are complex signals. For matching of the characteristics of a wireless communication signal, studies on a neural network for detecting a complex domain signal are further required.

Hereinafter, machine learning will be described in greater detail.

Machine learning refers to a series of operations to train a machine in order to build a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

### Terahertz (THz) Communication

THz communication is applicable to the 6G system. For example, a data rate may increase by increasing bandwidth. This may be performed by using sub-THz communication with wide bandwidth and applying advanced massive MIMO technology.

FIG. 9 shows an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

FIG. 10 shows a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Artificial Intelligence System

FIG. 11 shows a perceptron architecture in an artificial neural network applicable to the present disclosure. In addition, FIG. 12 shows an artificial neural network architecture applicable to the present disclosure.

As described above, an artificial intelligence system may be applied to a 6G system. Herein, as an example, the artificial intelligence system may operate based on a learning model corresponding to the human brain, as described above. Herein, a paradigm of machine learning, which uses a neural network architecture with high complexity like artificial neural network, may be referred to as deep learning. In addition, neural network cores, which are used as a learning scheme, are mainly a deep neural network (DNN), a convolutional deep neural network (CNN), and a recurrent neural network (RNN). Herein, as an example referring to FIG. 11, an artificial neural network may consist of a plurality of perceptrons. Herein, when an input vector x={x₁, x₂, . . . , x_{d}} is input, each component is multiplied by a weight {W₁, W₂, . . . , Wd}, results are all added up, and then an activation function o (.) is applied, of which the overall process may be referred to as a perceptron. For a large artificial neural network architecture, when expanding the simplified perceptron structure illustrated in FIG. 11, an input may be applied to different multidimensional perceptrons. For convenience of explanation, an input value or an output value will be referred to as a node.

Meanwhile, the perceptron structure shown in FIG. 11 may be described to consist of a total of 3 layers based on an input value and an output value. An artificial neural network, which has H (d+1)-dimensional perceptrons between the 1^{st} layer and the 2^{nd} layer and K (H+1)-dimensional perceptrons between the 2^{nd} layer and the 3^{rd} layer, may be expressed as in FIG. 12.

Herein, a layer, in which an input vector is located, is referred to as an input layer, a layer, in which a final output value is located, is referred to as an output layer, and all the layers between the input layer and the output layer are referred to as hidden layers. As an example, 3 layers are disclosed in FIG. 12, but since an input layer is excluding in counting the number of actual artificial neural network layers, it can be understood that the artificial neural network shown in FIG. 12 has a total of 2 layers. An artificial neural network is constructed by connecting perceptrons of a basic block two-dimensionally.

The above-described input layer, hidden layer and output layer are commonly applicable not only to multilayer perceptrons but also to various artificial neural network architectures like CNN and RNN, which will be described below. As there are more hidden layers, an artificial neural network becomes deeper, and a machine learning paradigm using a sufficiently deep artificial neural network as a learning model may be referred to as deep learning. In addition, an artificial neural network used for deep learning may be referred to as a deep neural network (DNN). FIG. 13 shows a deep neural network applicable to the present disclosure.

Referring to FIG. 13, a deep neural network may be a multilayer perceptron consisting of 8 layers (hidden layers+output layer). Herein, the multilayer perceptron structure may be expressed as a fully-connected neural network. In a fully-connected neural network, there may be no connection between nodes in a same layer and only nodes located in neighboring layers may be connected with each other. A DNN has a fully-connected neural network structure combining a plurality of hidden layers and activation functions so that it may be effectively applied for identifying a correlation characteristic between an input and an output. Herein, the correlation characteristic may mean a joint probability between the input and the output.

FIG. 14 shows a convolutional neural network applicable to the present disclosure. In addition, FIG. 15 shows a filter operation of a convolutional neural network applicable to the present disclosure.

As an example, depending on how to connect a plurality of perceptrons, it is possible to form various artificial neural network structures different from the above-described DNN. Herein, in the DNN, nodes located in a single layer are arranged in a one-dimensional vertical direction. However, referring to FIG. 14, it is possible to assume a two-dimensional array of w horizontal nodes and h vertical nodes (the convolutional neural network structures of FIG. 14). In this case, since a weight is applied to each connection in a process of connecting one input node to a hidden layer, a total of h×w weights should be considered. As there are h×w nodes in an input layer, a total of h²w² weights may be needed between two neighboring layers.

Furthermore, as the convolutional neural network of FIG. 14 has the problem of exponential increase in the number of weights according to the number of connections, the presence of a small filter may be assumed instead of considering every mode of connections between neighboring layers. As an example, as shown in FIG. 15, weighted summation and activation function operation may be enabled for a portion overlapped by a filter.

At this time, one filter has a weight corresponding to a number as large as its size, and learning of a weight may be performed to extract and output a specific feature on an image as a factor. In FIG. 15, a 3×3 filter may be applied to a top rightmost 3×3 area of an input layer, and an output value, which is a result of the weighted summation and activation function operation for a corresponding node, may be stored at z₂₂.

Herein, as the above-described filter scans the input layer while moving at a predetermined interval horizontally and vertically, a corresponding output value may be put a position of a current filter. Since a computation method is similar to a convolution computation for an image in the field of computer vision, such a structure of deep neural network may be referred to as a convolutional neural network (CNN), and a hidden layer created as a result of convolution computation may be referred to as a convolutional layer. In addition, a neural network with a plurality of convolutional layers may be referred to as a deep convolutional neural network (DCNN).

In addition, at a node in which a current filter is located in a convolutional layer, a weighted sum is calculated by including only a node in an area covered by the filter and thus the number of weights may be reduced. Accordingly, one filter may be so used as to focus on a feature of a local area. Thus, a CNN may be effectively applied to image data processing for which a physical distance in a two-dimensional area is a crucial criterion of determination. Meanwhile, a CNN may apply a plurality of filters immediately before a convolutional layer and create a plurality of output results through a convolution computation of each filter.

Meanwhile, depending on data properties, there may be data of which a sequence feature is important. A recurrent neural network structure may be a structure obtained by applying a scheme, in which elements in a data sequence are input one by one at each timestep by considering the distance variability and order of such sequence datasets and an output vector (hidden vector) output at a specific timestep is input with a very next element in the sequence, to an artificial neural network.

FIG. 16 shows a neural network architecture with a recurrent loop applicable to the present disclosure. FIG. 17 shows an operational structure of a recurrent neural network applicable to the present disclosure.

Referring to FIG. 16, a recurrent neural network (RNN) may have a structure which applies a weighted sum and an activation function by inputting hidden vectors {z₁^{(t-1)}, z₂^{(t-1)}, . . . , z_{H}^{(t-1)}} of an immediately previous timestep t−1 during a process of inputting elements {x₁^{(t)}, x₂^{(t)}, . . . , X_{d}⁽¹⁾} of a timestep t in a data sequence into a fully connected neural network. The reason why such hidden vectors are forwarded to a next timestep is because information in input vectors at previous timesteps is considered to have been accumulated in a hidden vector of a current timestep.

In addition, referring to FIG. 17, a recurrent neural network may operate in a predetermined timestep order for an input data sequence. Herein, as a hidden vector {z₁⁽¹⁾, z₂⁽¹⁾, . . . , z_{H}⁽¹⁾} at a time of inputting an input vector {x₁^{(t)}, x₂^{(t)}, . . . , x_{d}^{(t)}} of timestep 1 into a recurrent neural network is input together with an input vector {x₁⁽²⁾, x₂⁽²⁾, . . . , x_{d}⁽²⁾} of timestep 2, a vector {z₁⁽²⁾, z₂⁽²⁾, . . . , z_{H}⁽²⁾} of a hidden layer is determined through a weighted sum and an activation function. Such a process is iteratively performed at timestep 2, timestep 3 and until timestep T.

Meanwhile, when a plurality of hidden layers are allocated in a recurrent neural network, this is referred to as a deep recurrent neural network (DRNN). A recurrent neural network is so designed as to effectively apply to sequence data (e.g., natural language processing).

Apart from DNN, CNN and RNN, other neural network cores used as a learning scheme include various deep learning techniques like restricted Boltzmann machine (RBM), deep belief networks (DBN) and deep Q-Network, and these may be applied to such areas as computer vision, voice recognition, natural language processing, and voice/signal processing.

Recently, there are attempts to integrate AI with a wireless communication system, but these are concentrated in an application layer and a network layer and, especially in the case of deep learning, in a wireless resource management and allocation filed. Nevertheless, such a study gradually evolves to a MAC layer and a physical layer, and there are attempts to combine deep learning and wireless transmission especially in a physical layer. As for a fundamental signal processing and communication mechanism, AI-based physical layer transmission means application of a signal processing and communication mechanism based on an AI driver, instead of a traditional communication framework. For example, it may include deep learning-based channel coding and decoding, deep learning-based signal estimation and detection, deep learning-based MIMO mechanism, and AI-based resource scheduling and allocation.

### Specific Embodiments of the Present Disclosure

The present disclosure relates to a technology in which a base station and a user equipment (UE) communicate at the physical layer based on artificial-intelligence (AI)/machine-learning (ML) models. Because AI/ML models operate on data and the wireless channel between the base station and the UE changes continuously, online learning is required. A plurality of base stations may transmit reference signals, control channel signals, and data channel signals to the UE through multiple transmit antennas. For such communication, the present disclosure proposes a technique for efficiently performing online learning of AI/ML models.

When the plurality of base stations and the UE transmit and receive reference signal, control channel, and data channel signals through multiple transmission-and-reception points (multi-TRP), the base station and the UE may exchange quasi-colocation (QCL) information. Based on the QCL information, the UE and the base station may improve transmit-and-receive performance. However, QCL information is described according to antenna geometry as well as the mathematical transmit-and-receive model and the base-station implementation. When an AI/ML model is used at the physical layer, the AI/ML technique may not be fully exploited, because such usage is not data-based operation that reflects the real environment. For example, even if two transmit points are not QCL, communication-channel correlation may exist between the base station and the UE when their channel environments are similar.

In addition, QCL information is based on similarity of first- or second-order statistical information related to a large scale. That is, QCL represents at least one of Doppler shift, Doppler spread, average delay, delay spread, and spatial reception parameters. Therefore, QCL information cannot reflect the associated mutual information in high-dimensional representations used by AI/ML, especially deep neural networks. For example, if frequency- or time-domain profiles beyond first- or second-order statistics are identical, the deep-learning neural network needs to recognize such identity.

To solve the foregoing problem, the present disclosure proposes that the base station and the UE agree on mutual correlation in a high-dimensional representation of the UE's AI/ML model, beyond the static colocation concept related to position. To capture the mutual correlation, meta-learning theory for AI/ML may be used. A model that has undergone meta-learning has the advantage of rapidly performing a new task with a small amount of data. Accordingly, meta-learning may be suitable for handling physical-layer control and data signals related to time-varying channels.

Unlike QCL information, the data-based AI/ML models of various embodiments may use actually measured information. It is desirable to combine actual channel data with AI/ML so as to obtain better performance than conventional communication through online learning.

Meta-learning is a training technique that enables a pretrained neural network to perform inference, such as regression or classification, for a new task. For example, meta-learning may be understood as “learning-to-learn”, which allows effective learning and inference for a new task.

In meta-learning, the weights of a neural network that has been pretrained over tasks are called meta model parameters θ, and learning the meta-model parameters is defined as meta-training. When a new task is encountered, the meta-model parameters θ are relearned into task-adapted model parameters ¢, and performing inference based on the adapted parameters o is called adaptation. In the present disclosure, the model parameters for a task may be referred to as task-model parameters to distinguish them from the meta-model parameters.

Meta-learning is explained through a more intuitive example, as shown in FIG. 18. FIG. 18 shows a concept of meta-learning applicable to the present disclosure. Referring to FIG. 18, the practitioner wishes to handle a new task, ‘riding a bicycle’ (1802). If meta-training has been performed in advance on existing tasks of ‘riding something,’ the practitioner may ride the bicycle easily. If the meta-model parameters θ have been learned by training on tasks such as horseback riding (1812), surfing (1814), and riding an electric unicycle (1816) before the new task is given, adaptation to the new task of riding a bicycle may be performed relatively easily. Provided that optimally trained model parameters θ* for ‘riding something’ are given, the model parameters

$${ϕ}_{new\_task}^{*}$$

that may perform the new task may be determined as shown in [Equation 1] below.

$${ϕ}_{new\_task}^{*} = arg {max}_{ϕ} log p ( ϕ \vert {D}_{meta\_test} , {θ}^{*} ) \qquad [ Equation 1 ]$$

In [Equation 1],

$${ϕ}_{new\_task}^{*}$$

denotes the task-model parameter for the new task, φ denotes a task-model parameter, D_{meta_test} denotes a data set for meta-testing, and θ* represents the optimal meta-model parameter. For example, according to [Equation 1], when the data set and the optimal meta-model parameter are given, a task-model parameter that probabilistically optimizes the model for the target task may be determined as the task-model parameter for the new task.

From the viewpoint of probabilistic modeling, a task-probability distribution p(T) may be considered when numerous tasks exist. Data may be collected from the task-probability distribution p(T), and the meta-model parameter θ may be learned based on the model f_{θ}. At this time, the task may be defined as shown in [Equation 2].

$$T = \{ ℒ ( {f}_{θ} , D ) , ρ ( {x}_{t + 1} \vert {x}_{t} , {y}_{t} ) , H \} \qquad [ Equation 2 ]$$

In [Equation 2], T denotes a task, [symbol] denotes a loss function, f_{θ} denotes a neural-network model, D denotes a related data set, ρ(xₜ₊₁|xₜ, yₜ) denotes a conditional transition probability of task data, and H represents the temporal length of the corresponding task. In meta-training, an objective function for learning the meta-model parameter θ and a data set from the task distribution may be defined as shown in

$${θ}^{*} = arg {min}_{θ} {𝔼}_{( x , y ) ∈ D ∼ p ( D \vert T )} [ ℒ ( {f}_{θ} , {D}_{meta\_train} ) ] = arg {max}_{θ} log p ( θ \vert {D}_{meta\_train} ) \qquad [ Equation 3 ]$$

In [Equation 3], θ* denotes the optimal meta-model parameter, E[ ] denotes the mean operator, D denotes a related data set, x,y denotes a data sample, p (D|T) denotes the data distribution for task T, L( ) denotes a loss function; f_{θ} denotes a meta-model, D_{meta_train} denotes a data set selected for meta-learning; and θ denotes meta-model parameters.

FIGS. 19a and 19b show examples of data sets for meta-learning applicable to the present disclosure. Referring to FIGS. 19a and 19b, a data set for meta-training (e.g., a meta-training set and a meta-test set) may include data sets of a plurality of different tasks. Within one task, the data set may include a training set (1922) (e.g., Dₜᵣ) and a test set (1924) (e.g., Dₜₛ). By gathering such individual task data, a meta-training set may be formed. For example, a transmitter and a receiver may determine task-specific task-model parameters through an inner loop using the training set (1922), and may determine meta-model parameters through an outer loop using the test set (1924).

Adaptation for a new specific task is to maximize a conditional-probability value that best explains a meta-test data set for that task, based on the optimal meta-model parameter θ*. The meta-test data set is also divided into a training set (1932) and a test set (1934). Here, the training set (1932) is mainly used to learn a task-model parameter

$${ϕ}_{new\_task}^{*}$$

for the new task from θ*. The test set (1934) is used for performing the actual task. The process of determining the optimal meta-model parameter θ* is meta-training.

Meta-learning algorithms for obtaining θ* may be classified into three broad categories. Model-based (e.g., black-box) methods, optimization-based methods, and non-parametric methods have been proposed. These three methods share the following commonalities. First, they generalize data obtained from a distribution of multiple tasks. Second, they sample one task from a meta-task data set and repeatedly perform learning using the related task data Dₜᵣ and Dₜₛ.

Meta-learning algorithms and their inner and outer loops are as follows.

A model-based method determines θ* using another model or neural network di that well explains a sampled task i. An optimization-based method does not retain a separate model that best explains task I, instead, it determines θ* using gradient information of the current model. A non-parametric method considers a model that well represents the feature of φᵢ for task i.

Meta-learning shows good performance when a data set has a long-tail distribution. For a long-tail data set, there are many classes, and the data size within each class is very small, from a classification perspective. Meta-learning also achieves good performance with small data sets. The most useful application example is few-shot learning. Even when only a few images are presented, excellent performance is achieved by identifying the images after performing meta-learning.

Meta-learning algorithms may be divided into a model-based approach, an optimization-based approach, and a non-parametric approach. Each algorithm may be described as follows.

TABLE 2

| algorithms | Contents |
|---|---|
| model-based approach | 1. Sample Task i |
| | 2. Sample data set Dⁱₜᵣ, Dⁱₜₛ |
| | 3. Compute φᵢ←f_{θ}(Dⁱₜᵣ) |
| | 4. update θ using ∇_{θ}L(φᵢ, Dⁱₜₛ) |
| | 5. return to 1. |
| optimization-based | 1. Sample Task i |
| approach | 2. Sample data set Dⁱₜᵣ, Dⁱₜₛ |
| | 3. Optimize φᵢ←∇_{θ}L(θ, Dⁱₜᵣ) |
| | 4. update θ using ∇_{θ}L(φᵢ, Dⁱₜₛ) |
| | 5. return to 1. |
| non-parametric | 1. Sample Task i |
| approach | 2. Sample data set Dⁱₜᵣ, Dⁱₜₛ |
| | 3. Compute |
| | 4. update θ using ∇_{θ}L(y^{ts}, y\hat{^{ts}}) |
| | 5. return to 1. |

A common feature of meta-learning algorithms is that they consist of an inner loop that determines φᵢ by repeatedly processing individual tasks i in step #3,and an outer loop that covers steps #4 and #1 and determines θ* using φᵢ based on the inner loop. θ* denotes the parameter that best generalizes the distribution of tasks. Accordingly, meta-learning may be understood as hierarchical parameter learning with two levels.

Meta-learning tasks according to various embodiments of the present disclosure may relate to synchronization signals, reference signals, control channels, and data channels. For example, the present disclosure concerns meta-learning of transmit-and-receive tasks related to at least one of synchronization signals, reference signals, control channels, and data channels in communication. The present disclosure defines conventional communication operations that must be performed according to the purpose of a signal as tasks. For example, channel estimation—estimating a channel by using an AI/ML model that takes a reference signal as input—corresponds to an inference task in the AI/ML model. Reception of control channel or data bits by a base station or a UE corresponds to a classification task in the AI/ML model. Specifically, transmit-and-receive tasks may be defined for various procedures such as channel estimation using a synchronization or reference signal, processing of data signals (e.g., encoding/decoding, modulation/demodulation), beam management, and synchronization.

While performing transmit and receive operations, the UE and the base station may perform various tasks, which may be understood as simultaneous multi-task execution. If the base station operates multiple transmission-and-reception points (TRPs), a single synchronization or reference signal transmitted per TRP may be transmitted and received through one signal task. Therefore, multiple TRPs correspond to multiple signal tasks. Tasks of an AI/ML model for transmitting and receiving control channel and data channel signals may be associated with synchronization- or reference signal tasks. All tasks related to control and data channels may also be processed based on meta-learning. A task set {Tᵢ} for reference, control, and data signals may be defined sequentially during a specific time interval H in online learning.

The present disclosure defines meta-correlation (MCR) as a concept related to meta-learning. Although the correlation of signals transmitted from multiple points is expressed by QCL information, it may be interpreted as the correlation among multiple tasks at multiple points from an AI/ML perspective. Therefore, the present disclosure addresses the correlation of multiple tasks from a meta-learning perspective. If the meta-learning model parameter θ* reflects the correlation among task-model parameters φ₀, φ₁, . . . , φ_{N-1} included in a task set related to each point, the correlation among the tasks may be defined as meta-correlation. Based on the meta-model parameter θ* that reflects multi-point tasks, adaptation to the model parameter φᵢ of an arbitrary multi-point task may be performed rapidly.

For example, meta-correlation for transmit-and-receive operations of a base station and a UE that use an AI/ML model f_{θ} may be defined as correlation, at the feature or deep-representation level, among tasks included in the task set {Tᵢ} for reference, control, and data signals transmitted from multiple TRPs. By exchanging and utilizing information related to meta-correlation of tasks for multiple TRPs, the base station and the UE may enhance the performance of transmit-and-receive tasks. Meta-correlation may be determined using QCL information and, additionally, using data obtained from the actual communication environment that are delivered to the base station through a UE measurement report. The base station may improve task speed and performance by providing other UEs with information related to the determined meta-correlation. The meta-correlation proposed in the present disclosure may represent correlation among TRPs. However, meta-correlation may also be applied to describe or represent correlation not only among TRPs but also among ports. For convenience of explanation below, TRPs are presented as examples of targets to which meta-correlation is applied.

Meta-correlation for a target task Tᵢ may be determined by measuring the loss or performance of the target task φᵢ for multiple candidate meta-parameter values θ corresponding to weighted combinations of the model parameters φ₀, φ₁, . . . , φ_{N-1} of tasks in multiple TRPs. The meta-correlation of the target task Tᵢ may be represented by the optimal vector Vᵢ among candidate meta-correlation vectors v=[v₀, . . . v_{N-1}] for the model parameters φ₀, φ₁, . . . , φ_{N-1} of other tasks.

$${V}_{i} = arg {max}_{v} log p ( {ϕ}_{i} \vert {D}_{i}^{ts} , {θ}_{v} ) \qquad [ Equation 4 ]$$

In [Equation 4], Vᵢ refers to meta-correlation information related to other tasks of task i, v refers to a meta-correlation vector, φᵢ refers to a task-model parameter tor task i,

$${D}_{i}^{ts}$$

refers to a test data set for task i, and θᵥ refers to a meta-model parameter based on the meta-correlation vector.

$${θ}_{v} = arg {max}_{θ , v} {\sum }_{i} {v}_{i} log p ( {ϕ}_{i} \vert {D}_{i}^{tr} ) , {ϕ}_{i} = {f}_{θ} ( {D}_{i}^{tr} ) , v = [ {v}_{0} , ¨ , {v}_{N - 1} ] \qquad [ Equation 5 ]$$

In [Equation 5], θᵥ denotes a meta-model parameter based on the meta-correlation vector, θ denotes a meta-model parameter, v denotes a meta-correlation vector, vᵢ denotes the i-th element of the meta-correlation vector, φᵢ denotes a task-model parameter for task i,

$${D}_{i}^{tr}$$

denotes a training data set for task i, and f_{θ} denotes a meta-model.

Referring to [Equation 4] and [Equation 5], the contribution of data from other tasks that best assist the target task may be reflected in meta-learning. For example, assume two tasks To and T₁ related to an SSB (synchronization signal and physical broadcast channel block) and three tasks T₂, T₃, T₄ related to a CSI-RS exist. When the target task is the CSI-RS-related task T₃, a meta-correlation vector V₃, including values that indicate the correlation of each of the other four tasks, may be determined. When the elements of the meta-correlation vector indicate only whether each task contributes (e.g., 0 or 1) instead of real-valued weights between 0 and 1, it becomes possible to distinguish transmit-and-receive tasks of multiple TRPs that are helpful to the meta-learning task. Accordingly, According to an embodiment, the UE may receive information related to the optimal vector V₃, determine, through relatively light computation, a meta-model parameter

$${θ}_{{V}_{3}^{*}}$$

that is most helpful to the current task T₃ based on V₃, and then perform task adaptation.

A channel may depend on factors such as the UE's antenna, position, velocity, acceleration (motion vector), posture, posture-related angular velocity, rotational velocity, terrain, and the influence of moving objects around the UE. UEs with similar listed characteristics may be grouped into a single logical unit. The present disclosure defines a combination of the listed characteristics as a UE channel context (UE context). A UE context may be used to identify multiple UEs with highly correlated channels or multiple UEs that share a specific terrain. Meta-correlation may furthermore be identified per UE context. Supported UE contexts for identifying meta-correlation may be determined by agreement between the base station and the UE.

For example, a first UE carried by a pedestrian walking along the roadside and a second UE mounted in a fast-moving automobile may be divided into two groups. Although their delay spreads may be similar, the first and second UEs may be separated into two groups owing to the difference in speed. As an example, a third UE in an office environment and a fourth UE outside the building may be distinguished by their channel profiles. In that case, the channel profiles of the third and fourth UEs may differ. The UE channel context may also vary with the antenna and hardware form factor of the UE. Because a UE in the form of a small IoT device and a UE mounted in a vehicle have different antenna types, they will likely experience different channels.

FIG. 20 shows functional structures of devices that support meta-learning according to an embodiment of the present disclosure. FIG. 20 illustrates a transmit-and-receive model in which, among two devices (2010 and 2020) that communicate according to an embodiment, the first device (2010) functions as a transmitter, and the second device (2020) functions as a receiver. For downlink communication, the first device (2010) may be regarded as a base station and the second device (2020) as a UE. For uplink communication, the first device (2010) may be regarded as a UE and the second device (2020) as a base station.

Referring to FIG. 20, the first device (2010) includes a transmit entity (2011), a meta trainer (2012), a meta transmitter (2013), an adaptation block (2014), and a task transmitter (2015). The transmit entity (2011) performs overall control and processing for data transmission. For example, the transmit entity (2011) may generate transmit data and provide information required for the operation of other blocks. Specifically, the transmit entity (2011) may provide task data to the meta trainer (2012) and provide message S to the task transmitter (2015). At this time, the transmit entity (2011) may control a meta-learning operation by using feedback information (e.g., a measurement report, CSI information, loss information) received from the second device (2020). The meta trainer (2012) determines meta-model parameters by performing meta-learning, and the meta transmitter (2013) stores the meta-model parameters determined through meta-learning. The adaptation block (2014) determines a task-model parameter for a given task by performing adaptation on the meta-model parameters, and the task transmitter (2015) processes the message and at least one reference signal according to the task by using the adapted task-model parameter obtained through adaptation. According to an embodiment, meta-correlation information (e.g., a meta-correlation vector) and task-model parameters of other tasks may be used to determine the meta-model parameters and the task-model parameters.

Referring to FIG. 20, the second device (2020) includes a receive entity (2021), a meta trainer (2022), a meta receiver (2023), an adaptation block (2024), a task receiver (2025), and a TX meta control block (2026). The receive entity (2021) performs overall control and processing for data reception. For example, the receive entity (2021) may process a received message and provide information required for the operation of other blocks. Specifically, the receive entity (2021) may provide task data to the meta trainer (2022) and provide message S to the task receiver (2025). The meta trainer (2022) determines meta-model parameters by performing meta-learning, and the meta receiver (2023) stores the meta-model parameters determined through meta-learning. The adaptation block (2024) determines a task-model parameter for a given task by performing adaptation on the meta-model parameters, and the task receiver (2025) restores the message by processing the message and at least one reference signal according to the task using the adapted task-model parameter, and provides the restored message Ŝ to the receive entity (2021). The TX meta control block (2026) generates information for training the transmit models of the first device (2010) and transmits a measurement report including the generated information to the first device (2010). According to an embodiment, meta-correlation information (e.g., a meta-correlation vector) and task-model parameters of other tasks may be used to determine the meta-model parameters and the task-model parameters.

Referring to FIG. 20, the meta-model may consist of one or more meta transmitters (2013) and one or more meta receivers (2023). The meta-model includes generalized parameter values θ^{T} and θ^{R} obtained by meta-training over multiple tasks. Here, θ^{T} and θ^{R} may be determined based on meta-correlation information. Task models may consist of one or more task transmitters (2015) and one or more task receivers (2025). Task models may have different parameters for each reference signal task. When transmitting an actual message S, the meta-model is converted-via adaptation-into transmit and receive task models suited to the current channel condition, and the message S is transmitted and received by using those task models. Finally, the second device (2020) restores the message Ŝ. The transmit entity (2011) and the receive entity (2021) denote the entities that transmit and receive data. The meta trainers (2012) and (2022) learn the meta-parameters θ^{T} and θ^{R} by using information related to the transmit task model φ^{T} and the receive task model φ^{R}. The TX meta control block (2026) is the controller of the second device (2020) for training the transmitter model. According to an embodiment, the TX meta control block (2026) measures a loss for training the transmit model and feeds the loss back to the first device (2010) through a measurement report.

A transmitter and receiver that perform online meta-learning carry out two processes concurrently. The first process is an online meta-training process. The online meta-training process searches for the meta-model parameter θ* that yields the best performance at the present moment. Through an inner loop, the online meta-training process determines each task parameter φ of the transmitter and receiver learned from multiple tasks. The online meta-training process also determines a meta-model parameter θ* that well generalizes the task parameters through an outer loop. The second process performs adaptation based on the latest meta-parameter θ* using training data obtained from a recently used task, and then carries out transmission and reception by using the φ obtained through adaptation. At that time, according to an embodiment, the transmitter and receiver may perform meta-learning that determines parameters for a target task by using parameters of other tasks based on meta-correlation.

FIG. 21 shows a procedure for determining parameters related to a transmitter according to an embodiment of the present disclosure. FIG. 21 illustrates a UE operation method, and the illustrated operations may be understood as those of the receiver (e.g., the second device 2020 in FIG. 20).

Referring to FIG. 21, in step S2101, the UE transmits capability information. For example, the UE transmits a message that includes capability information. The capability information may include information related to the UE's communication capabilities. According to an embodiment, the capability information may include information related to meta-learning. For example, such information may include at least one of: information related to at least one AI/ML model, information related to at least one task, and information indicating at least one meta-learning algorithm. Furthermore, the meta-learning-related information may relate to meta-learning that uses meta-correlation. Although not shown in FIG. 21, the UE may receive from the base station a message that requests the capability information before transmitting it.

In step S2103, the UE receives configuration information related to a reception operation. For example, the UE receives a message including configuration information for processing signals transmitted by the base station. For example, the configuration information may include at least one of: information related to a signal, information related to signal processing, and information related to a subsequent operation corresponding to signal reception. Specifically, information related to the signal may include at least one of: information related to resources and information related to the physical form of the signal (e.g., structure, value, numerology, coding rate, modulation order). According to an embodiment, the configuration information may include configuration information related to meta-learning. For example, such configuration information may include at least one of: information related to the structure of a meta-model, information related to meta-model parameters, information related to a meta-learning algorithm, information related to meta-correlation (e.g., values indicating the correlation among combinable tasks), and information related to UE context. According to an embodiment, the configuration information related to meta-learning may be transmitted via a separate message.

In step S2105, the UE receives signals based on the configuration information. For example, the UE receives the signals according to at least one of the resources, structure, and physical form indicated by the configuration information. Here, the signals may include one of a synchronization signal, a reference signal, a data channel signal, and a control channel signal. For example, at least some of the signals may relate to the target task and may be received over multiple occasions.

In step S2107, the UE determines at least one parameter for a reception operation. For example, the UE may configure a receiver for processing the signal. According to an embodiment, the UE may perform meta-learning. At this time, the UE may perform meta-learning by using meta-correlation. Specifically, the UE determines the contribution of the task-model parameters of at least one other task, relative to the target task, based on meta-correlation information, selects at least one other task according to the determined contribution, and then determines meta-model parameters based on the task-model parameters of the at least one task. The UE may then determine a task-model parameter for the target task by performing adaptation based on the meta-model parameters. For example, the UE may determine meta-model and task-model parameters for the target task based on the meta-correlation information. At this time, in some cases, at least one of the meta-correlation information and the meta-model parameters may be updated or redetermined.

In step S2109, the UE transmits feedback information. After determining at least one parameter for the reception operation, the UE may transmit the feedback information. The feedback information may include at least one of: measurement results for a reference signal and ACK/NACKs for a data signal. According to an embodiment, the feedback information may include at least one of: information related to meta-correlation and UE-context information. For example, by transmitting feedback information including at least one of meta-correlation information that indicates at least one task used to determine the meta-model parameters, the meta-model parameters, and UE-context information, the UE may provide information that aids meta-learning of other UEs. Although not shown in FIG. 21, the UE may receive a request from the base station for transmission of the feedback information before transmitting it.

FIG. 22 shows a procedure for determining parameters related to a receiver according to an embodiment of the present disclosure. FIG. 22 illustrates an operation method of the base station, and the illustrated operations may be understood as those of the receiver (e.g., the first device 2010 in FIG. 20).

Referring to FIG. 22, in step S2201, the base station receives capability information. For example, the base station receives a message that includes capability information from the UE. The capability information may include information related to the UE's communication capabilities. According to an embodiment, the capability information may include information related to meta-learning. For example, such information may include at least one of: information related to at least one AI/ML model, information related to at least one task, and information indicating at least one meta-learning algorithm. Furthermore, the meta-learning-related information may pertain to meta-learning that uses meta-correlation. Although not shown in FIG. 22, the base station may transmit a message requesting the capability information to the UE before receiving it.

In step S2203, the base station transmits configuration information related to the reception operation. For example, the base station transmits a message including configuration information for processing signals that it will transmit. For example, the configuration information may include at least one of: information related to signals, information related to signal processing, and information related to subsequent operations corresponding to signal transmission. Specifically, information related to the signal may include at least one of: information related to resources and information related to the physical form of the signal (e.g., structure, value, numerology, coding rate, modulation order). According to an embodiment, the configuration information may include settings related to meta-learning. For example, configuration information related to meta-learning may include at least one of: information related to the meta-model structure, information related to meta-model parameters, information related to a meta-learning algorithm, information related to meta-correlation (e.g., values indicating correlations among combinable tasks), and information related to the UE context. According to an embodiment, configuration information related to meta-learning may be transmitted in a separate message.

In step S2205, the base station transmits signals based on the configuration information. For example, the base station transmits the signals according to at least one of the resources, structure, and physical form indicated by the configuration information. Here, the signals may include one of a synchronization signal, a reference signal, a data channel signal, and a control channel signal. For example, at least some of the signals may relate to the target task and may be transmitted over multiple occasions.

In step S2207, the base station receives feedback information. The base station may receive feedback information from the UE after the UE has determined at least one parameter for the reception operation. The feedback information may include at least one of: measurement results for a reference signal and ACK/NACKs for a data signal. According to an embodiment, the feedback information may include at least one of information related to meta-correlation or information related to the UE context. For example, by receiving feedback information that includes at least one of meta-correlation information indicating at least one task used by the UE to determine meta-model parameters, the meta-model parameters themselves, and the UE-context information, the base station may obtain information to assist meta-learning of other UEs.

Although not shown in FIG. 22, the base station may transmit the UE a request to transmit the feedback information before receiving it.

FIG. 23 shows a procedure for determining meta-model parameters according to an embodiment of the present disclosure. FIG. 23 illustrates a UE operation method, and the illustrated operations may be understood as those of the receiver (e.g., the second device 2020 in FIG. 20).

Referring to FIG. 23, in step S2301, the UE obtains information related to meta-correlation. For example, the meta-correlation-related information may pertain to a meta-correlation vector determined by another UE and may include at least one meta-correlation vector, meta-model parameters determined based on at least one meta-correlation vector, or information that specifies multiple tasks mapped to the respective elements of at least one meta-correlation vector. If the meta-correlation-related information includes multiple meta-correlation vectors, meta-correlation vectors may have ranks or priorities. According to an embodiment, the UE may receive the meta-correlation-related information from the base station. Here, the other UE may be one of the UEs that share the same UE context.

In step S2303, the UE determines tasks for meta-learning based on information related to meta-correlation. For example, the UE determines tasks that are used to determine meta-model parameters. According to an embodiment, the UE may select a task set indicated by at least one meta-correlation vector obtained in step S2301. According to an embodiment, the UE may determine multiple candidate meta-correlation vectors based on at least one meta-correlation vector obtained in step S2301, and may select one of the multiple candidate meta-correlation vectors. For example, multiple candidate meta-correlation vectors may include multiple meta-correlation vectors obtained in step S2301 or multiple meta-correlation vectors derived from at least one meta-correlation vector obtained in step S2301.

In step S2305, the UE performs meta-learning based on the determined tasks. For example, the UE determines meta-model parameters from the task-model parameters of the determined tasks. For meta-learning, the UE may obtain training data by using signals received from the base station. For example, the UE may determine a task-model parameter for each selected task and then determine meta-model parameters that generalize those task-model parameters. For example, the UE may obtain the meta-model parameters by solving an optimization problem such as [Equation 3].

Next, although FIG. 23 does not show the step, the UE performs adaptation to obtain task-model parameters from the meta-model parameters and then performs the task using those task-model parameters. For example, the UE may process signals corresponding to the task (e.g., channel estimation, phase compensation, positioning, decoding, or information acquisition) by using the task-model parameters).

Additionally, although FIG. 23 does not show the step, the UE may transmit information related to the applied meta-correlation. Consequently, another UE may perform meta-learning more effectively by using the meta-correlation vector employed by the reporting UE. Specifically, meta-correlation information transmitted to the base station may be delivered by the base station to another UE sharing the same UE context. For example, meta-correlation information fed back to the base station by the UE may assist meta-learning performed by another UE.

In the embodiment described with reference to FIG. 23, the UE determines task-model parameters for the tasks selected for meta-learning. However, according to an embodiment, for example, the task-model parameters may be provided by the base station. In that case, the UE may obtain meta-model parameters by using the received task-model parameters without determining the task-model parameters independently. According to an embodiment, even after receiving task-model parameters from the base station, the UE may update or redetermine those task-model parameters and then obtain the meta-model parameters by using the updated task-model parameters.

FIG. 24 shows an example procedure for providing capability information for meta-learning based on meta-correlation for a receiver, according to an embodiment of the present disclosure. FIG. 24 illustrates signaling between a first device (2410) and a second device (2420).

Referring to FIG. 24, in step S2401, the first device (2410) transmits a request message to the second device (2420) requesting capability information related to meta-correlation. The meta-learning capability-request message may be transmitted during or after a registration procedure, once the second device (2420) has attached to the first device (2410). The request message may be referred to as an MCR-capability request message or a capability-inquiry message.

In step S2403, the second device (2420) transmits a response message that includes capability information related to meta-correlation to the first device (2410). The response message may be referred to as an MCR-capability response message or a capability-information message. The response message may include at least one of the following: information that indicates at least one neural-network model learnable by using meta-correlation; information that indicates at least one task learnable by using meta-correlation; and information that indicates at least one supportable meta-learning algorithm. Additionally, the response message may further include various capability information related to other communication functions beyond the meta-correlation.

As described with reference to FIG. 24, capability information related to meta-correlation of the second device (2420) may be provided. In addition, capability information related to meta-learning of the second device (2420) may also be provided. Additionally, capability information related to meta-learning or meta-correlation of the first device (2410) may likewise be provided to the second device (2420) via the request message. Accordingly, the information elements (IEs) or parameters included in the request and response messages may include at least one of the items listed in [Table 3] below.

TABLE 3

| Information | |
|---|---|
| element | Description |
| set of support | A set of AI/ML models that support meta-correlation |
| models | or their related identifiers |
| set of support | A set of tasks that support meta-correlation or |
| tasks | their related identifiers, this task set pertains |
| | to reference signal, control, and data channel |
| | signals |
| set of support | A set of supportable meta-learning algorithms |
| meta- algorithms | or their related identifiers |

FIG. 25 shows an example procedure for configuring information for meta-learning according to an embodiment of the present disclosure. FIG. 25 illustrates signaling between a first device (2510) and a second device (2520) for configuring information for meta-learning.

Referring to FIG. 25, in step S2501, the first device (2510) transmits a request message to the second device (2520) for configuration related to meta-learning that uses meta-correlation. For example, the first device (2510) requests that meta-learning based on meta-correlation be performed. The request message may be referred to as an MRC setup request message or an MRC reconfigure request message. The request message includes the information required to perform meta-learning. For example, the request message may include at least one of information indicating a meta-model, information indicating at least one other task available for meta-learning, information indicating correlation values that constitute the meta-correlation, information indicating a meta-learning algorithm, or information indicating a UE context.

In step S2503, the second device (2520) transmits a confirmation message to the first device (2510) for the configuration of meta-learning that uses meta-correlation. For example, the second device (2520) transmits a response indicating acceptance of the meta-learning based on meta-correlation. The confirmation message may be referred to as an MRC setup confirm message or an MRC reconfigure confirm message. For example, the second device (2520) responds that it has obtained the information in the request message or has completed the necessary configuration for learning based on that information. Next, procedures for receiving various signals may be performed for the meta-learning.

As described with reference to FIG. 25, the information required for the second device (2520) to perform meta-learning using meta-correlation may be provided. Specifically, the information elements or parameters included in the request and confirmation messages may include at least one of the items listed in [Table 4] below.

TABLE 4

| Information element | Description |
|---|---|
| Meta-model | Meta-model or related identifier |
| set of meta-tasks | A multi-TRP task set, each task may be linked |
| associated | to one or a combination of a synchronization |
| with signals | signal, a reference signal, a control channel |
| | signal, or a data channel signal. each signal |
| | description may include antenna-port information. |
| Meta-correlations | Meta-correlation of the multi-TRP task set |
| Meta-algorithm | Meta-learning algorithm or related identifier |
| set of UE contexts | UE context or related identifier |

FIG. 26 shows an example procedure for performing meta-learning and tasks according to an embodiment of the present disclosure. FIG. 26 illustrates signaling between a first device (2610) and a second device (2620) for configuring information for meta-learning.

Referring to FIG. 26, in step S2601, the first device (2610) transmits signals for meta-tasks. Here, the signals may be classified by task. For example, the signals may include at least one of a reference signal, a control channel signal, and a data channel signal. The signals may be transmitted at different timings depending on their type. The signals may be transmitted over resources allocated for meta-learning, or may be scheduled according to each signal's purpose. The signals are continuously transmitted during communication and may subsequently be used for meta-learning and task execution.

In step S2603, the second device (2620) performs meta-learning using meta-correlation to obtain meta-parameters. According to an embodiment, the second device (2620) first performs online meta-learning on a multi-TRP task set defined within a specific time interval. Next, the second device (2620) trains to obtain a meta-model parameter θᵥ* based on meta-correlation information V. For example, the meta-model parameter

$${θ}_{v}^{*}$$

may be expressed as in [Equation 6] below.

$${θ}_{v}^{*} = arg {max}_{θ , V} {\sum }_{i} {v}_{i} log p ( {ϕ}_{i} \vert {D}_{i}^{tr} ) \qquad [ Equation 6 ]$$

In [Equation 6],

$${θ}_{v}^{*}$$

based on the meta-correlation vector, θ denotes a meta-model parameter, V denotes meta-correlation information, vᵢ is the i-th element of the meta-correlation vector, φᵢ is a task-model parameter for task i,

$${D}_{i}^{tr}$$

is a training-data set for task i, and f_{θ} represents the meta-model.

For example, the second device (2620) may determine task-model parameters for multiple tasks, evaluate each task's contribution to the target task, select a subset of task-model parameters according to these contributions, and determine meta-model parameters for the target task based on the selected subset. The second device (2620) then performs adaptation based on the meta-model parameters to obtain task-model parameters for the target task and performs the target task using those parameters. At that time, the multiple tasks used may include task-model parameters produced by meta-learning performed by the second device (2620) itself or by other UEs that share the same UE context.

In step S2605, the second device (2620) performs each task through adaptation based on the meta-model parameters obtained via meta-correlation. For example, the second device (2620) determines task-model parameters for each task by performing adaptation based on the meta-model parameters derived from meta-correlation. The second device (2620) may then perform each task by using the corresponding task-model parameters.

FIG. 27 shows an example procedure for performing online meta-learning according to an embodiment of the present disclosure. FIG. 27 illustrates signaling between a first device (2710) and a second device (2720).

Referring to FIG. 27, in step S2701, the first device (2710) transmits a meta-training request message to the second device (2720). The meta-training request message includes information related to the set of signal tasks used during meta-training. Additionally, the request message may further include at least one of: the batch size for gradient-based training, the optimization method, and other related configuration values. Additionally, the message may include information related to the task set for each inner loop and the task set used in the outer loop. Next, in step S2703, the first device (2710) transmits at least one signal for task k. After the first device (2710) transmits the at least one signal for task k, in step S2705, the second device (2720) updates the parameters of its receive model. The parameters of the receive neural network may be updated as shown in [Equation 7] below.

$${ϕ}^{R} = u ( {ϕ}^{R} , {∇}_{{θ}^{R}} L ( {θ}^{T} , {ϕ}^{R} ) ) \qquad [ Equation 7 ]$$

In [Equation 7], φ^{R} denotes a task-model parameter of the receiver, u represents the update function, L( ) represents the loss function, and θ^{T} denotes the transmitter's meta-model parameter. Here, the update function u may vary depending on the optimization method.

Next, in step S2707, the second device (2720) reports the loss through a measurement report. For example, the second device (2720) determines the loss with respect to the first device (2710) and transmits a measurement report including information related to the loss to the first device (2710). Next, in step S2709, the first device (2710) updates the transmit model. The training for task k performed in steps S2703 through S2709, for example, the initial phase of meta-learning—may provide a preliminary learning opportunity so that the transmitter and receiver networks remain up-to-date. This prevents the network parameters from becoming stale by learning only old channel conditions. However, According to an embodiment, for example, steps S2703 through S2709 may be omitted.

Next, in steps S2711-i through S2711-i+N, signals for tasks i through i+N are transmitted for the inner loops. Once these signals are transmitted, the inner loops update each task-model parameter φ^{R} in steps S2713-i through S2713-i+N. The task-model parameters may be updated as shown in [Equation 8].

$${ϕ}^{R} = {f}_{inner} ( {θ}^{R} , {∇}_{{θ}^{R}} L ( {ϕ}^{T} , {θ}^{R} ) ) \qquad [ Equation 8 ]$$

In [Equation 8], φ^{R} denotes the receiver's task-model parameter, fᵢₙₙₑᵣ represents the meta-learning function used in the inner loop, θ^{R} denotes the receiver's meta-model parameter, and L( ) represents the loss function. Here, fᵢₙₙₑᵣ may vary depending on the chosen meta-learning approach.

Next, in steps S2715-j through S2715-j+M, the first device (2710) transmits signals for tasks j through j+M. In step S2727, the second device (2720) samples at least one of the transmitted tasks and updates the meta-model parameter θ^{R} in the outer loop based on the task-model parameters φ^{R} updated in the inner loop. The meta-model parameter may be updated as expressed in [Equation 9].

$${θ}^{R} = {f}_{outer} ( {θ}^{R} , {∇}_{{θ}^{R}} L ( {ϕ}^{T} , {ϕ}^{R} ) ) \qquad [ Equation 9 ]$$

In [Equation 9], θ^{R} denotes the receiver's meta-model parameter, fₒᵤₜₑᵣ represents the meta-learning function used in the outer loop, L( ) represents the loss function, and φ^{T} denotes the transmitter's task-model parameter for a specific task. Here, fₒᵤₜₑᵣ varies according to the meta-learning approach.

FIG. 28 shows an example procedure for reporting meta-correlation information according to an embodiment of the present disclosure. FIG. 28 illustrates signaling for reporting the results of meta-learning between a first device (2810) and a second device (2820).

Referring to FIG. 28, in step S2801, the first device (2810) transmits a request message to the second device (2820) for reporting meta-correlation information. The request message may be referred to as an MRC report request message. For example, the first device (2810) may request the second device (2820) to provide measurement results for the meta-correlation. For example, the request message may include at least one of: information indicating a meta-model; information indicating the set of tasks related to the request; information indicating the relevant meta-learning algorithm; and information related to the UE context.

In step S2803, the second device (2820) searches for a set of meta-correlation vectors by solving an optimization problem. Here, the purpose of the optimization problem is to determine whether each task contributes at least a given level to the target task. For example, the optimization problem may be defined as in [Equation 5]. Through this process, the second device (2820) may obtain at least one meta-correlation vector. At that time, the at least one obtained meta-correlation vector may be treated as meta-correlation information related to the UE context indicated in the request message.

In step S2805, the second device (2820) transmits a report message for the set of meta-correlation vectors to the first device (2810). The report message may be referred to as a set of

MRC vectors report message. For example, the second device (2820) transmits information related to the at least one meta-correlation vector determined in step S2803. For example, the report message may include at least one of information indicating the at least one meta-correlation vector or information related to the UE context.

As described with reference to FIG. 28, the second device (2820) may provide information related to at least one meta-correlation vector. According to an embodiment, the request message may include at least one of the items listed in Table 5 below.

TABLE 5

| Information element | Description |
|---|---|
| Meta-model | Meta-model or related identifier |
| set of meta-tasks | Multi-TRP task set, each task may be linked |
| associated | to one or a combination of a synchronization |
| with signals | signal, a reference signal, a control channel |
| | signal, or a data channel signal. each signal |
| | description may include antenna-port information. |
| Meta-algorithm | Meta-learning algorithm or related identifier |
| set of UE contexts | UE context or related identifier |

According to an embodiment, the report message may include at least one of the items listed in [Table 6] below.

TABLE 6

| Information element | Description |
|---|---|
| set of meta-correlation | Meta-correlation measurement |
| vectors | values among tasks |
| UE context | UE context for the meta-correlation |

The items in [Table 5] may be used when the first device (2810) (e.g., the base station) requests meta-correlation for a preconfigured multi-TRP task set. However, the first device (2810) may request measurement of the meta-correlation for synchronization signals and common reference signals discovered through autonomous search by the second device (2820) (e.g., a UE). In that case, the request message may include at least one of the items listed in [Table 7] below.

TABLE 7

| Information element | Description |
|---|---|
| Meta-model | Meta-model or related identifier |
| Meta-algorithm | Meta-learning algorithm or related identifier |
| Autonomous request | Indicator requesting meta-correlation |
| indicator | measurement for synchronization and common |
| | reference signals discovered via UE search |

FIG. 29 shows an example use-case in which tasks are performed by employing meta-correlation according to an embodiment of the present disclosure. FIG. 29 shows a situation where multiple transmission points (TPs) (2920-1 to 2920-6) transmit data channel signals related to a reference signal to the UE (2910).

Referring to FIGS. 29, TP2 (2920-2) and TP3 (2920-3) are in a QCL or meta-correlation relationship based on the base-station design, and TP4 (2920-4) and TP5 (2920-5) likewise have a QCL or meta-correlation relationship. By using meta-correlation, not only the first-order and second-order statistics of QCL but also the high-dimensional channel distribution, which is a key strength of AI/ML models, may be reflected in the meta-parameter θ. In this case, the meta-task parameters may represent the spread-profile shape in the frequency domain and the delay-spread shape in the time domain within the deep neural network. If the channels between UE (2910) and TP1 (2920-1) and those between UE (2910) and TP2 (2920-2) are similar from a meta-correlation standpoint, the base station may obtain a meta-correlation vector via the UE's meta-correlation reporting procedure (e.g., the procedure of FIG. 28).

When the delay profiles among UE (2910), TP1 (2920-1), TP2 (2920-2), and TP6 (2920-6) happen to be similar—CDL Type A—because of the terrain, these delay profiles may be indicated to both the base station and UE (2910) by using meta-correlation information. For example, from TP1's viewpoint, the meta-correlation allows the meta-representation domain to readily obtain high-dimensional AI/ML information related to the channel-delay profile, included in φ_{RS2}, P_{data2}, φ_{RS6}, φ_{data6}, for the reference signal task φ_{RS1}. For example, by rapidly obtaining meta-information among multiple transmission points via a meta-correlation vector, the efficiency and performance of transmissions between the UE (2910) and the base station may be enhanced.

As in the various embodiments described above, leveraging data-driven operation with meta AI/ML techniques allows real channel profiles to be shared even when two transmission points are not in a QCL relationship. QCL information corresponds to first-order and second-order statistics at a large-scale level. For example, QCL reflects only the Doppler shift, Doppler spread, average delay, delay spread, and spatial RX parameters. Therefore, reflecting mutual information in the high-dimensional representation offered by AI/ML—especially deep neural networks—may yield greater performance gains. To this end, the proposed technique enables a deep-learning neural network to capture, via meta-parameters, cases where profiles in the frequency and time domains are identical beyond first-order and second-order statistics.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method for operating a user equipment (UE), the method comprising:
transmitting, to a base station, capability information;
receiving, from the base station, configuration information related to signals;
receiving the signals based on the configuration information;
determining at least one parameter for a reception operation by performing meta-learning based on meta-correlation information that represents contributions of task model parameters of a plurality of tasks to a target task, the meta-correlation information being determined using the signals; and
transmitting, to the base station, feedback information.

2. The method of claim 1,
wherein the feedback information includes at least one of information related to the meta-correlation or context information of the UE.

3. The method of claim 1,
wherein the capability information includes at least one of information related to at least one learnable neural network model using meta-correlation, information representing at least one learnable task using the meta-correlation, or information related to at least one supportable meta-learning algorithm.

4. The method of claim 1,
wherein the configuration information includes at least one of information related to a meta model, information representing at least one other task available for meta-learning, information related to correlation values forming meta-correlation, information related to a meta-learning algorithm, or information representing UE context.

5. The method of claim 1, further comprising:
receiving a request message that requests the feedback information.

6. The method of claim 5,
wherein the request message includes at least one of: information related to a meta-model; information related to a set of tasks associated with the request; information related to a corresponding meta-learning algorithm; and information related to UE context.

7. The method of claim 1,
determining the at least one parameter for the reception operation further comprises:
determining the task model parameters for the plurality of tasks;
determining the contributions of the plurality of tasks to the target task; and
determining meta model parameters for the target task, based on a part of the task model parameters of the plurality of tasks selected based on the contributions.

8. The method of claim 1,
wherein the meta-correlation information includes values representing whether the plurality of tasks contribute.

9. The method of claim 1,
wherein the task model parameters for the plurality of tasks is determined through meta-learning performed by another UE having the same UE context.

10. A method for operating a base station, the method comprising:
receiving, from a user equipment (UE), capability information;
transmitting, to the UE, configuration information related to signals;
transmitting the signals based on the configuration information;
receiving, from the UE, feedback information,
wherein the feedback information is related to at least one parameter for a reception operation determined by performing meta-learning based on meta-correlation information that represents contributions of task model parameters of a plurality of tasks to a target task, the meta-correlation information being determined using the signals.

11. The method of claim 10,
wherein the feedback information includes at least one of information related to the meta-correlation or context information of the UE.

12. The method of claim 10,
wherein the capability information includes at least one of information related to at least one learnable neural network model using meta-correlation, information representing at least one learnable task using the meta-correlation, or information related to at least one supportable meta-learning algorithm.

13. The method of claim 10,
wherein the configuration information includes at least one of information related to a meta model, information representing at least one other task available for meta-learning, information related to correlation values forming meta-correlation, information related to a meta-learning algorithm, or information representing UE context.

14. The method of claim 10, further comprising:
transmitting a request message that requests the feedback information,
wherein the request message includes at least one of: information related to a meta-model; information related to a set of tasks associated with the request; information related to a corresponding meta-learning algorithm; and information related to UE context.

15. A user equipment (UE) comprising:
a transceiver; and
a processor connected to the transceiver,
wherein the processor is configured to perform operations comprising:
transmitting, to a base station, capability information;
receiving, from the base station, configuration information related to signals;
receiving the signals based on the configuration information;
determining at least one parameter for a reception operation by performing meta-learning based on meta-correlation information that represents contributions of task model parameters of a plurality of tasks to a target task, the meta-correlation information being determined using the signals; and
transmitting, to the base station, feedback information.

16-18. (canceled)

19. The UE of claim 15,
wherein the feedback information includes at least one of information related to the meta-correlation or context information of the UE.

20. The UE of claim 15,
wherein the capability information includes at least one of information related to at least one learnable neural network model using meta-correlation, information representing at least one learnable task using the meta-correlation, or information related to at least one supportable meta-learning algorithm.

21. The UE of claim 15,
wherein the configuration information includes at least one of information related to a meta model, information representing at least one other task available for meta-learning, information related to correlation values forming meta-correlation, information related to a meta-learning algorithm, or information representing UE context.
